(19) United States
(12) Patent Application Publication
(10) Pub. No.: US 2022/0083879 A1
(43) Pub. Date: Mar. 17, 2022

(54) INFERRING A COMPARATIVE ADVANTAGE OF MULTI-KNOWLEDGE REPRESENTATIONS

(71) Applicant: KT CORPORATION, Seongnam-si (KR)

(72) Inventors: Dae Woong JO, Seoul (KR); Gyu Tae BAEK, Seoul (KR)

(21) Appl. No.: 17/456,604

(22) Filed: Nov. 26, 2021

Related U.S. Application Data
(63) Continuation of application No. PCT/KR2020/006120, filed on May 8, 2020.

(30) Foreign Application Priority Data
May 28, 2019 (KR) 10-2019-0062612

(51) Int. Cl. G06N 5/04; G06F 16/242; G06F 16/2452

(52) U.S. Cl. CPC G06N 5/04; G06F 16/24526; G06F 16/243

(57) ABSTRACT

Generating a response to a natural language-based query includes extracting a subject keyword, an object keyword and a query type of a natural language from the natural language; generating a query knowledge graph including the subject keyword, the object keyword and the query type; searching a plurality of query knowledge graphs including the subject keyword; deriving information relevant to the object keyword from map data based on the subject keyword of each of the plurality of searched query knowledge graphs; and providing a query result for the natural language based on the derived information and the query type.

### TECHNICAL FIELD

The present disclosure relates to inferring a comparative advantage of multiple knowledge representations.

### BACKGROUND

A conventional natural language-based query search system structuralizes a natural language graph through semantic interpretation of the natural language, and uses a method of searching, in a knowledge database, a graph with high similarity to the structuralized natural language graph, for example, a graph that is of the same shape as, and is semantically similar to, the structuralized natural language graph.

In other words, the conventional query search system performs a query search by calculating a graph similarity value by comparing the graph stored in the knowledge database to the structuralized natural language graph.

A conventional query search system performs a one-to-one mapping between at least one graph searched from the knowledge database and the structuralized natural language graph or a comparative recursion in the form of a sentence and thus requires multiple operations, causing a delay in search.

Also, a conventional query search system performs a processing method that is dependent on the graph structure, i.e., a method of matching and processing graphs. Thus, when the natural language is complicated or the structure of the graph stored in the knowledge database is complicated, the accuracy in query search is reduced.

### DISCLOSURE OF THE INVENTION

### Problems to be Solved by the Invention

The solutions described and recited herein solve the above-described problems of the prior art, generating a query knowledge graph that includes a subject keyword, an object keyword, and a query type of a natural language that are extracted from the natural language. Also, the solutions described and recited herein include searching a plurality of query knowledge graphs that include the subject keyword extracted from the natural language and deriving information relevant to the object keyword of the natural language from relation keyword-based map data that is generated based on information mapped to each of the plurality of searched query knowledge graphs. Further, the solutions described and recited herein include providing a query result for the natural language based on the derived information and the query type of the natural language.

The problems to be solved by the present disclosure are not limited to the above-described problems. There may be other problems to be solved by the present disclosure.

### Means for Solving the Problems

According to an aspect of the present disclosure, a server that provides a response to a natural language-based query includes a query knowledge graph generation unit that extracts a subject keyword, an object keyword, and a query type of a natural language from the natural language and generates a query knowledge graph including the subject keyword, the object keyword, and the query type; a query knowledge graph search unit that searches a plurality of query knowledge graphs including the subject keyword; an information deriving unit that derives information relevant to the object keyword from map data based on the subject keyword of each of the plurality of searched query knowledge graphs; and a search result providing unit that provides a query result for the natural language based on the derived information and the query type.

According to another aspect of the present disclosure, a method for providing a response to a natural language-based query by a server includes extracting a subject keyword, an object keyword, and a query type of a natural language from the natural language; generating a query knowledge graph including the subject keyword, the object keyword, and the query type; searching a plurality of query knowledge graphs including the subject keyword; deriving information relevant to the object keyword from map data based on the subject keyword of each of the plurality of searched query knowledge graphs; and providing a query result for the natural language based on the derived information and the query type.

According to the other aspect of the present disclosure, a computer program that is stored in a storage medium and includes a sequence of instructions for providing a response to a natural language-based query, wherein the computer program includes a sequence of instructions that, when executed by a computing device, causes the computing device to extract a subject keyword, an object keyword, and a query type of a natural language from the natural language; to generate a query knowledge graph including the subject keyword, the object keyword, and the query type; to search a plurality of query knowledge graphs including the subject keyword; to derive information relevant to the object keyword from map data based on the subject keyword of each of the plurality of searched query knowledge graphs; and to provide a query result for the natural language based on the derived information and the query type.

The above-described aspects are provided by way of illustration only and should not be construed as liming the present disclosure. Besides the above-described embodiments, there may be additional embodiments described in the accompanying drawings and the detailed description.

### Effects of the Invention

According to any one of the above-described means for solving the problems, a query knowledge graph that includes a subject keyword, an object keyword, and a query type of a natural language, which are extracted from the natural language, is generated. Also, a plurality of query knowledge graphs that include the subject keyword extracted from the natural language is searched and information relevant to the object keyword of the natural language from relation keyword-based map data that is generated based on information mapped to each of the plurality of searched query knowledge graphs is derived. Further, a query result for the natural language based on the derived information and the query type of the natural language is provided.

The solutions described and recited herein including searching the plurality of query knowledge graphs relevant to the subject keyword when the query knowledge graph corresponding to the natural language is generated and deriving the information relevant to the object keyword of the natural language in the plurality of searched query knowledge graphs, rather than searching a query search result by using the similarity of each knowledge graph. Accordingly, there is no need to calculate all relationships between components of the natural language and convert them into a similar graph.

The solutions described and recited herein significantly reduce the time required for search of a query result for the natural language and also improve the accuracy of query result.

Further, even for natural language that is complicated in structure, the solutions described and recited herein include generating a query knowledge graph having the same structure as the natural language rather than converting the natural language into a graph as it is.

Furthermore, by the solutions described and recited herein, an object keyword may be predicted using ranking data based on user preference even if the object keyword is not included in the natural language, a value corresponding to the predicted object keyword may be derived, and the value may be provided as a query result for the natural language.

### BRIEF DESCRIPTION OF THE DRAWINGS

FIG. 1 is a block diagram of a server that provides a response to a natural language-based query, in accordance with an embodiment of the present disclosure.

FIG. 2A is an example depiction to explain a method of generating a query knowledge graph, in accordance with at least one embodiment of the present disclosure.

FIG. 2B is an example depiction to explain the method of generating a query knowledge graph, in accordance with the at least one embodiment of the present disclosure.

FIG. 2C is an example depiction to explain the method of generating a query knowledge graph, in accordance with the at least one embodiment of the present disclosure.

FIG. 2D is an example depiction to explain the method of generating a query knowledge graph, in accordance with the at least one embodiment of the present disclosure.

FIG. 3 is an example depiction comparing a conventional natural language-based query result search structure and a natural language-based query result search structure of the present disclosure, in accordance with the one or more embodiments of the present disclosure.

FIG. 4A is an example depiction to explain a method of providing a response to a natural language-based query, in accordance with at least one embodiment of the present disclosure.

FIG. 4B is an example depiction to explain the method of providing a response to a natural language-based query, in accordance with the at least one embodiment of the present disclosure.

FIG. 4C is an example depiction to explain the method of providing a response to a natural language-based query, in accordance with the at least one embodiment of the present disclosure.

FIG. 5 is an example depiction to explain a method of constructing user preference-based ranking data, in accordance with one or more embodiments of the present disclosure.

FIG. 6 is an example depiction showing the importance in a query knowledge graph, in accordance with one or more embodiments of the present disclosure.

FIG. 7 is an example depiction to explain a method of deriving a result for an abstract comparative advantage query by using user preference-based ranking data, in accordance with one or more embodiments of the present disclosure.

FIG. 8 is a flowchart illustrating an example processing flow for providing a response to a natural language-based query, in accordance with one or more embodiments of the present disclosure.

### BEST MODE FOR CARRYING OUT THE INVENTION

Hereafter, embodiments of the present disclosure will be described in detail with reference to the accompanying drawings so that the present disclosure may be readily implemented by a person with ordinary skill in the art. However, it is to be noted that the present disclosure is not limited to the embodiments but may be embodied in various other ways. In drawings, parts irrelevant to the description are omitted for the simplicity of explanation, and like reference numerals denote like parts through the whole document.

Throughout the whole document, the terms “connected to” and/or “coupled to” may be used to designate a connection or coupling of one element to another element includes both a case that an element is “directly connected or coupled to” another element and a case that an element is “electronically connected or coupled to” another element via still another element. Further, through the whole document, the term “comprises or includes” and/or “comprising or including” used in the document means that one or more other components, steps, operation and/or existence or addition of elements are not excluded in addition to the described components, steps, operation and/or elements unless context dictates otherwise.

Throughout the whole document, the term “unit” may pertain to a unit implemented by hardware, software, and/or both in combination. Further, one unit may be implemented by two or more pieces of hardware, and two or more units may be implemented by one piece of hardware.

Throughout the whole document, a part of an operation or function described as being carried out by a terminal or device may be carried out by a server connected to the terminal or device. Likewise, a part of an operation or function described as being carried out by a server may be carried out by a terminal or device connected to the server.

Hereafter, the present disclosure will be explained in detail with reference to the accompanying configuration views or process flowcharts.

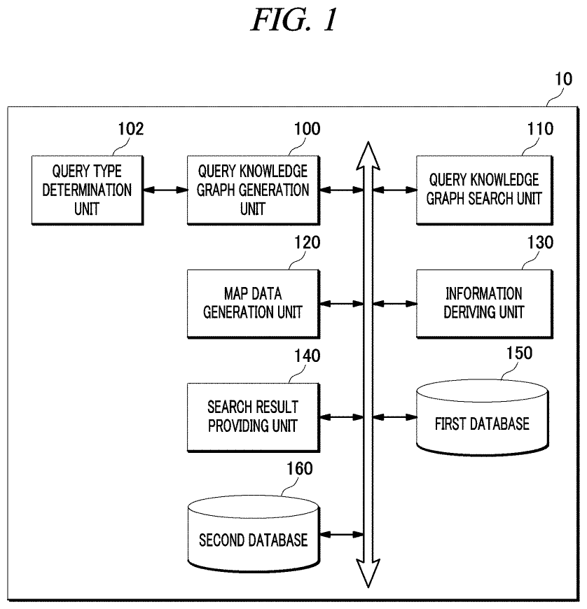

FIG. 1 is a block diagram of a server 10 that provides a result for a natural language-based query, in accordance with an embodiment of the present disclosure.

Referring to FIG. 1, the natural language-based query result providing server 10 may include a query knowledge graph generation unit 100, a query knowledge graph search unit 110, a map data generation unit 120, an information deriving unit 130, a search result providing unit 140, a first database 150, and a second database 160. The query knowledge graph generation unit 100 may include a query type determination unit 102. However, the natural language-based query result providing server 10 depicted in FIG. 1 and described herein is a non-limiting example embodiment.

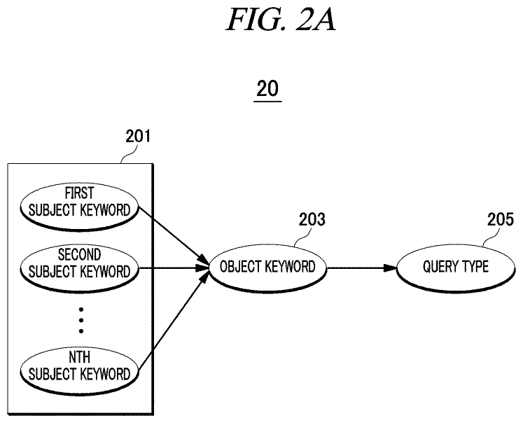

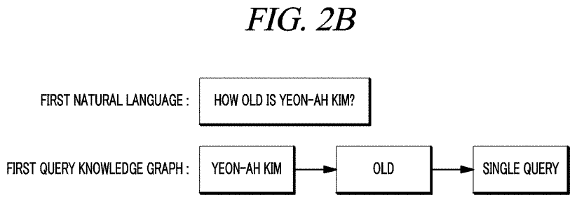

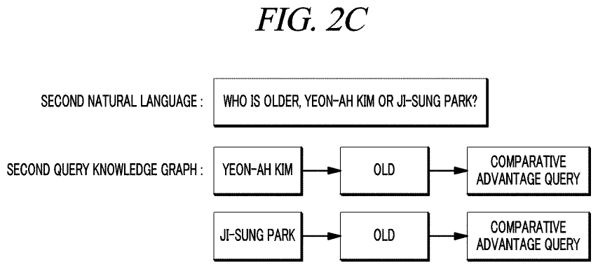

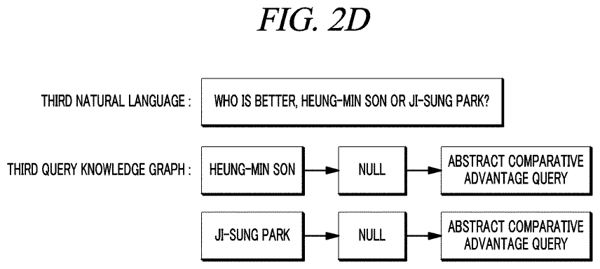

Hereafter, the description for FIG. 1 will include reference to FIG. 2A through FIG. 7.

The query knowledge graph generation unit 100 may extract a subject keyword, an object keyword, and a query type of a natural language from the natural language. Herein, the query type of the natural language may be determined by the query type determination unit 102 based on the number of subject keywords included in the natural language and the presence or absence of an object keyword.

When the natural language includes a single subject keyword and an object keyword, the query type determination unit 102 may determine the query type of the natural language to be a single query. For example, when an example first natural language query “How old is Yeon-ah Kim?” is input by a user, as depicted in FIG. 2B, the query knowledge graph generation unit 100 may extract “Yeon-ah Kim” as a subject keyword from the first natural language and extract “old” as an object keyword from the first natural language. In this example, since the first natural language includes the single subject keyword and the object keyword, the query type determination unit 102 may determine a query type of the first natural language to be a single query.

In accordance with one or more other example embodiments, when the natural language includes a plurality of subject keywords and an object keyword, the query type determination unit 102 may determine the query type of the natural language to be a comparative advantage query, by which a comparative operation is performed with regard to the plurality of subject keywords. For example, when an example second natural language query “Who is older, Yeon-ah Kim or Ji-sung Park?” is input by the user, as depicted in FIG. 2C, the query knowledge graph generation unit 100 may extract both “Yeon-ah Kim” and “Ji-sung Park” as subject keywords from the second natural language and extract “old” as an object keyword from the second natural language. In this example, since the second natural language includes a plurality of subject keywords (“Yeon-ah Kim” and “Ji-sung Park”) and the object keyword (“old”), the query type determination unit 102 may determine a query type of the second natural language to be a comparative advantage query.

In accordance with one or more other example embodiments, when the natural language includes only a plurality of subject keywords but does not include any object keyword, the query type determination unit 102 may determine the query type of the natural language to be an abstract comparative advantage query. For example, when an example third natural language query “Who is better, Heung-min Son or Ji-sung Park?” is input by the user, as depicted in FIG. 2D, the query knowledge graph generation unit 100 may extract both “Heung-min Son” and “Ji-sung Park” as subject keywords from the third natural language and the extraction of an object keyword would be “null” because the object keyword does not exist in the third natural language. In this example, since the third natural language includes only a plurality of subject keywords (“Heung-min Son” and “Ji-sung Park”) without any object keyword, the query type determination unit 102 may determine a query type of the third natural language to be an abstract comparative advantage query.

Even if the natural language is of various type, the query knowledge graph generation unit 100 may generate a query knowledge graph having the same structure as a graph comparison reference model 20, as depicted in the non-limiting example of FIG. 2A. The graph comparison reference model 20 may include, for example, a subject keyword 201, an object keyword 203 and a query type 205.

That is, the query knowledge graph generated from the natural language, regardless of the complexity of the natural language, is of the same type as the graph comparison reference model 20. If the natural language is a multi-knowledge comparative query, a reference group of a subject keyword corresponding to multi-knowledge representation may expand, but an object keyword corresponding to a direct target of multi-knowledge representation comparison may be processed as a single flow graph.

At least one subject keyword 201 in the graph comparison reference model 20 may correspond to at least one subject of the input natural language, and the object keyword 203 in the graph comparison reference model 20 may correspond to an object of the input natural language.

The query knowledge graph generation unit 100 may generate a query knowledge graph including a subject keyword, an object keyword, and a query type, which are extracted from a natural language, based on the graph comparison reference model 20.

A conventional query search system is required to understand a natural language and semantically interpret (i.e., understand and interpret a standardized query grammar to query a knowledge database and a SPARQL conversion grammar) in order to search a graph pattern structure identical to the natural language.

However, by the solutions described and recited herein, it possible to generate a query knowledge graph by inserting a subject keyword, an object keyword, and a query type into respective components of the graph comparison reference model 20 without understanding or interpreting a natural language when the subject keyword, the object keyword, and the query type are extracted from the natural language.

For example, for the first natural language query “How old is Yeon-ah Kim?” as depicted in FIG. 2B, the query knowledge graph generation unit 100 may generate a first query knowledge graph (Yeon-ah Kim-age-single query) including a subject keyword (“Yeon-ah Kim”), an object keyword (“old”), and a query type (“single query”) of the first natural language that are extracted from the first natural language.

As a further example, for the second natural language query “Who is older, Yeon-ah Kim or Ji-sung Park?” as depicted in FIG. 2C, the query knowledge graph generation unit 100 may generate a second query knowledge graph (“Yeon-ah Kim-age-comparative advantage query” and “Ji-sung Park-age-comparative advantage query”) including a first subject keyword (“Yeon-ah Kim”), a second subject keyword (“Ji-sung Park”), an object keyword (“old”), and a query type (“comparative advantage query”) of the second natural language that are extracted from the second natural language. In this example, the query knowledge graph generation unit 100 may generate a second query knowledge graph for each of the first subject keyword (“Yeon-ah Kim”) and the second subject keyword (“Ji-sung Park”).

As yet another example, for the third natural language query “Who is better, Heung-min Son or Ji-sung Park?” as depicted in FIG. 2D, the query knowledge graph generation unit 100 may generate a third query knowledge graph (“Heung-min Son-null-abstractive comparative advantage query” and “Ji-sung Park-null-abstract comparative advantage query”) including a first subject keyword (“Heung-min Son”), a second subject keyword (“Ji-sung Park”), an object keyword (“null”), and a query type (“abstract comparative advantage query”) of the third natural language that are extracted from the third natural language. In this example, the query knowledge graph generation unit 100 may generate a third query knowledge graph for both of the first subject keyword (“Heung-min Son”) and the second subject keyword (“Ji-sung Park”).

The query knowledge graph search unit 110 may search a plurality of query knowledge graphs including the subject keyword.

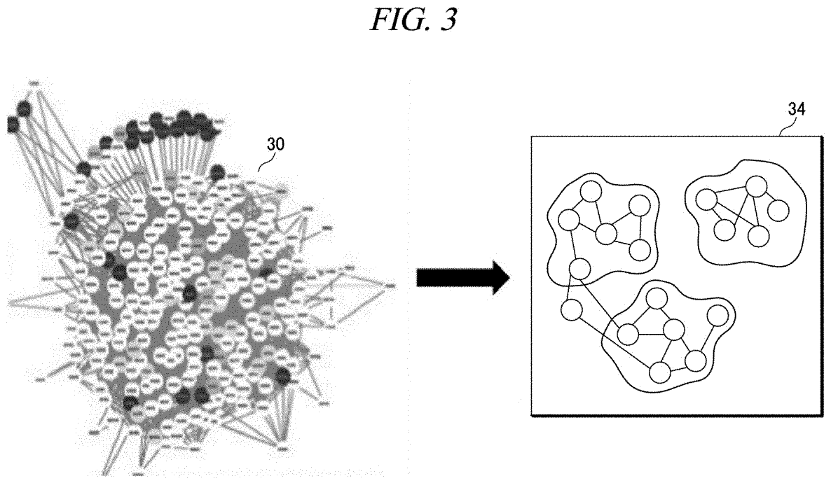

Referring to FIG. 3, the conventional natural language-based query result search structure uses a method of searching a graph pattern structure identical to a natural language from a knowledge database 30 through a graph matching technique 32. This is inefficient if the graph in the knowledge database 30 is complicated and massive in structure. Searching using the graph matching technique 32 is also inefficient, at least in terms of time, when the natural language is a multi-knowledge comparative query (e.g., a comparative advantage query, an abstract comparative advantage query, etc.) because a reference group may expand.

However, the natural language query result search structure (FIG. 3), in accordance with the solutions described and recited herein, searches a plurality of query knowledge graphs 34 including a subject keyword from the first database 150 that stores a plurality of query knowledge graphs and searches information relevant to an object keyword in the result of the searched plurality of query knowledge graphs 34 based on relation keyword-based map data. That is, upon input of a query, extracted subject keywords and object keywords may serve as a basis for a search of a query knowledge graph. Therefore, it is possible to considerably reduce the and operation quantity required for search as compared to the conventional natural language-based query result search structure.

The map data generation unit 120 may generate subject keyword-based map data including a plurality of relation keywords and values corresponding to the plurality of relation keywords, respectively, based on information mapped to each of the plurality of query knowledge graphs including the subject keyword searched from the first database 150. In this example, the plurality of relation keywords of the map data may correspond to object keywords included in the plurality of searched query knowledge graphs, respectively, and the values corresponding to the plurality of relation keywords, respectively, may be values corresponding to the object keywords included in the plurality of searched query knowledge graphs, respectively.

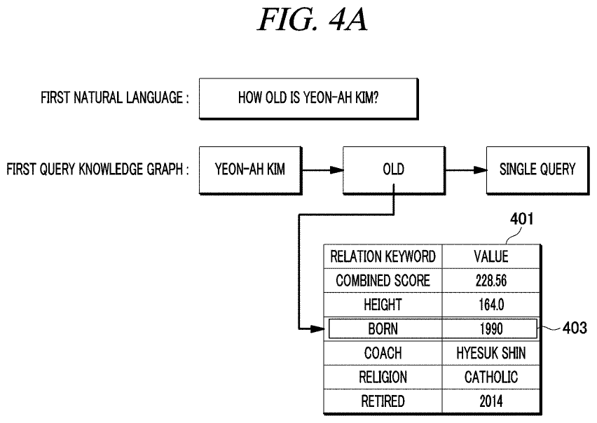

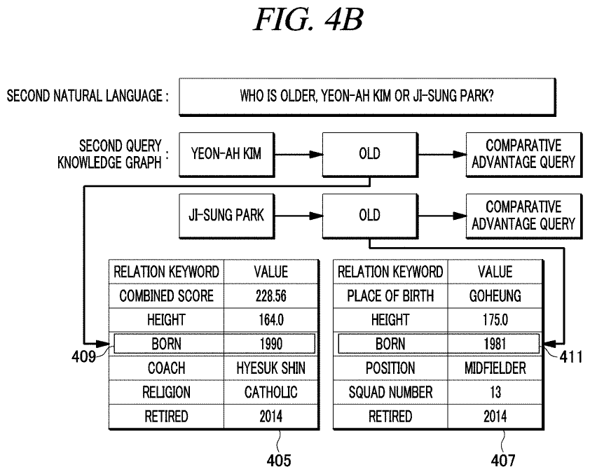

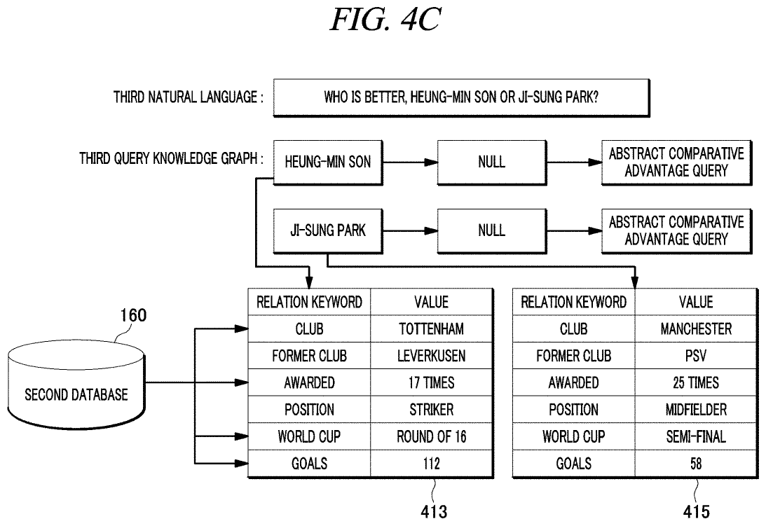

For example, referring to FIG. 4A, when a plurality of query knowledge graphs includes the subject keyword “Yeon-ah Kim” of the first natural language from the first database 150 that stores a plurality of query knowledge graphs, the map data generation unit 120 may generate first map data 401 based on information mapped to each of the plurality of query knowledge graphs including “Yeon-ah Kim.”

The information deriving unit 130 may derive information relevant to the object keyword from relation keyword-based map data based on the information mapped to each of the plurality of searched query knowledge graphs.

For example, again referring to FIG. 4A, when the query type of the first natural language is a single query, the information deriving unit 130 may detect data 403 including a relation keyword (“born”) relevant to “old,” which is the object keyword of the first natural language, and a value (“1990”) of the relation keyword (“born”) from the first map data 401 generated based on information mapped to each of the plurality of query knowledge graphs including “Yeon-ah Kim,” which is the subject keyword of the first natural language; and may derive a value corresponding to “old,” which is the object keyword, from the value (“1990”) of the relation keyword (“born”).

The search result providing unit 140 may provide a query result for the natural language based on the derived information and the query type. For example, again referring to FIG. 4A, when the query type of the first natural language is a single query, the information deriving unit 130 may provide a value (age of Yeon-ah Kim: 30) corresponding to “old,” which is the object keyword derived from the value (“1990”) of the relation keyword (“born”), as a query result for the first natural language.

When the natural language includes a plurality of subject keywords including a first subject keyword and a second subject keyword, the query knowledge graph search unit 110 may search a plurality of first query knowledge graphs including the first subject keyword and a plurality of second query knowledge graphs including the second subject keyword.

For example, referring to FIG. 4B, when the second natural language (“Who is older, Yeon-ah Kim or Ji-sung Park?”) includes a plurality of subject keywords (“Yeon-ah Kim” and “Ji-sung Park”), the query knowledge graph search unit 110 may search a plurality of first query knowledge graphs including “Yeon-ah Kim,” which is the first subject keyword of the second natural language, from the first database 150 and a plurality of second query knowledge graphs including “Ji-sung Park,” which is the second subject keyword.

Referring to FIG. 4C, when the third natural language (“Who is better, Heung-min Son or Ji-sung Park?”) includes a plurality of subject keywords (“Heung-min Son” and “Ji-sung Park”), the query knowledge graph search unit 110 may search a plurality first query knowledge graphs including “Heung-min Son,” which is the first subject keyword of the third natural language, from the first database 150 and a plurality of second query knowledge graphs including “Ji-sung Park,” which is the second subject keyword.

The map data generation unit 120 may generate first map data including a plurality of relation keywords and values corresponding to the plurality of relation keywords, respectively, based on information mapped to each of the plurality of searched first query knowledge graphs, and may generate second map data including a plurality of relation keywords and values corresponding to the plurality of relation keywords, respectively, based on information mapped to each of the plurality of searched second query knowledge graphs.

For example, again referring to FIG. 4B, when a plurality of query knowledge graphs for both of subject keywords “Yeon-ah Kim” and “Ji-sung Park” of the second natural language is searched from the first database 150, the map data generation unit 120 may generate first map data 405 based on information mapped to each of the plurality of query knowledge graphs including “Yeon-ah Kim” and may generate second map data 407 based on information mapped to each of the plurality of query knowledge graphs including “Ji-sung Park.”

Again referring to FIG. 4C, when a plurality of query knowledge graphs for each of the plurality of subject keywords “Heung-min Son” and “Ji-sung Park” of the third natural language is searched from the first database 150, the map data generation unit 120 may generate first map data 413 based on information mapped to each of the plurality of query knowledge graphs including “Heung-min Son” and may generate second map data 415 based on information mapped to each of the plurality of query knowledge graphs including “Ji-sung Park”.

When the query type of the natural language is a comparative advantage query, the information deriving unit 130 may derive information relevant to the object keyword from the generated first map data and may derive information relevant to the object keyword from the generated second map data.

Specifically, when the query type of the natural language is a comparative advantage query, the information deriving unit 130 may derive a first value corresponding to the object keyword from the first map data and may derive a second value corresponding to the object keyword from the second map data.

For example, again referring to FIG. 4B, the information deriving unit 130 may detect data 409 including a relation keyword (“born”) relevant to “old,” which is the object keyword of the second natural language, and a value (“1990”) of the relation keyword (“born”) from the first map data 405 generated based on information mapped to each of a plurality of query knowledge graphs including “Yeon-ah Kim,” which is the first subject keyword of the second natural language, and may derive a first value corresponding to “old,” which is the object keyword, from the value (“1990”) of the relation keyword (“born”).

Also, the information deriving unit 130 may detect data 411 including a relation keyword (“born”) relevant to “old,” which is the object keyword of the second natural language, and a value (“1981”) of the relation keyword (“born”) from the second map data 407 generated based on information mapped to each of a plurality of query knowledge graphs including “Ji-sung Park,” which is the second subject keyword of the second natural language, and may derive a second value corresponding to “old,” which is the object keyword, from the value (“1981”) of the relation keyword (“born”).

When the query type of the natural language is a comparative advantage query, the search result providing unit 140 may compare the first value and the second value corresponding to the object keyword of the natural language and derived from the first map data and the second map data, respectively, and may determine predominance among the first value and the second value based on the result of the comparison between the first value and the second value. Further, the search result providing unit 140 may provide a search result for the natural language.

For example, again referring to FIG. 4B, when the query type of the second natural language is a comparative advantage query, the search result providing unit 140 may advantageously compare the first value (age of Yeon-ah Kim: 30) and the second value (age of Ji-sung Park: 39) corresponding to the object keyword (“old”) of the second natural language and derived from the first map data 405 and the second map data 407, respectively, and may provide a search result (e.g., “Ji-sung Park is nine years older than Yeon-ah Kim”) for the second natural language.

When the query type of the natural language is an abstract comparative advantage query (a query in which an object keyword of the natural language is not clear), the information deriving unit 130 may infer a query result for the natural language by using user preference-based ranking data.

Herein, the user preference-based ranking data may be stored and kept in the second database 160. The user preference-based ranking data may be used to determine a comparative advantage (i.e., an abstract comparative advantage) between two knowledge representations without a direct reference to the object keyword in the natural language query. The user preference-based ranking data may be data ranked for a plurality of keywords appearing in a plurality of documents collected by subjects.

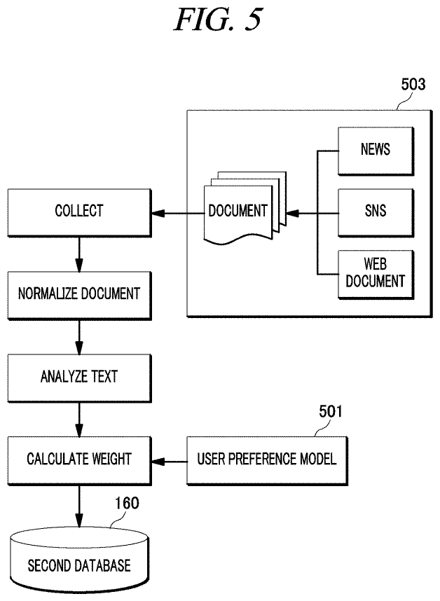

For example, referring to FIG. 5, a user preference model 501 may be used to calculate a weight for a main keyword mainly referred in various structured and unstructured data 503 and rank attribute data including the main keyword and a value corresponding to the main keyword based on the calculated weight.

Weights for a plurality of main keywords appearing a predetermined number of times or more in various structured and unstructured data (e.g., SNS data, news data, web documents, etc.) collected by subjects may be important attributes highly relevant to a subject keyword included in a query.

The user preference-based ranking data may be ranked based on a weight for a main keyword calculated through the user preference model 501 after various structured and unstructured data 503 collected by subjects are normalized, and stop words, which may affect the weight, are eliminated from the normalized document through text analysis on the normalized document and then stored in the second database 160.

When the query type of the natural language is an abstract comparative advantage query, the information deriving unit 130 may derive at least one predicted object keyword based on the user preference-based ranking data, derive information relevant to the predicted object keyword from the first map data, and derive information relevant to the predicted object keyword from the second map data.

Again referring to FIG. 4C, the information deriving unit 130 may derive, as a predicted object keyword of the third natural language, at least one relation keyword (“club,” “awards,” “World Cup” and “goals”) included in the map data 413 and 415 matched with user preference-based ranking data (high ranked data) relevant to the subject keywords (“Heung-min Son,” “Ji-sung Park”) of the third natural language among a plurality of user preference-based ranking data stored in the second database 160. In this example, the information deriving unit 130 may select a predicted object keyword (“awards,” “World Cup,” “goals”), which can be advantageously compared in value, from among at least one derived predicted object keyword (“club,” “awards,” “World Cup,” “goals”) of the third natural language.

Then, the information deriving unit 130 may derive a first value corresponding to the selected predicted object keyword from the first map data 413 and may derive a second value corresponding to the selected predicted object keyword from the second map data 415.

The search result providing unit 140 may advantageously compare the derived first and second values and may provide a search result for the natural language.

For example, referring to FIG. 4C, the information deriving unit 130 may derive a first value corresponding to a first predicted object keyword (“awards”), which can be advantageously compared in value, from the first map data 413 and may derive a second value corresponding to the first predicted object keyword (“awards”) from the second map data 415.

Then, the search result providing unit 140 may compare the first value (the number of awards received by Heung-min Son: 17) and the second value (the number of awards received by Ji-sung Park: 25) corresponding to the first predicted object keyword (“awards”) and derived from the first map data 413 and the second map data 415, respectively, and may provide a search result (e.g., “Ji-sung Park has received more awards than Heung-min Son”) for the third natural language.

According to the solutions described and recited herein, even if the third natural language does not include any object keyword, it is possible to derive and infer new knowledge representations from factual grounds including a knowledge database or a query knowledge graph by comparing multi-knowledge, as described above with reference to FIG. 4C. For example, according to the present disclosure, it is possible to generate comparative advantage knowledge such as “Who is older, Heung-min Son or Ji-sung Park?” or “Who has scored more goals, Heung-min Son or Ji-sung Park?” from “Who is better, Heung-min Son or Ji-sung Park?” which is the third natural language, and also possible to derive an answer to such knowledge. Therefore, according to the present disclosure, it is possible to infer new knowledge, which has not existed in the third natural language, and derive an answer to the generated knowledge.

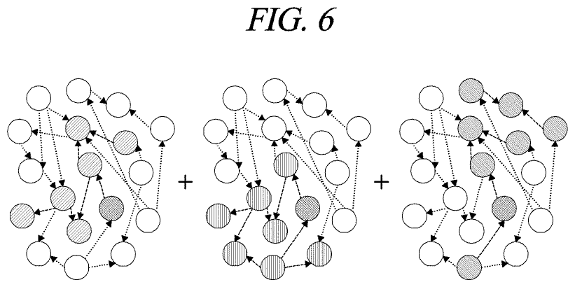

Referring to FIG. 5 and FIG. 6, nodes and relations, which are considered important in a plurality of query knowledge graphs, are displayed in different colors to indicate the relative importance among different knowledge representations. The important nodes and relations become basic elements when comparing different knowledge in value. If the elements calculated based on the importance between nodes of each query knowledge graph are the same, it can be presented as a basis for comparison of values in the same element.

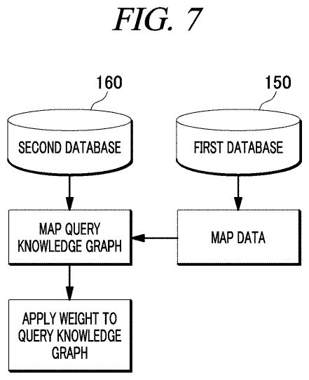

The user preference-based ranking data ranked by the user preference model 501 may be used to extract a relation attribute of a query knowledge graph. For example, referring to FIG. 4C and FIG. 7, when a keyword frequently appearing in a plurality of documents relevant to “Heung-min Son” is relevant to “goals,” “awards” and,” “Tottenham (current team),” if high ranked user preference-based ranking data (data stored in the second database 160) among these keywords are identical to a relation keyword of the map data 413 generated from the first database 150, the user preference-based ranking data may be mapped to the query knowledge graph and weights may be applied to nodes and relations in the query knowledge graph.

A person with ordinary skill in the art would understand that each of the query knowledge graph generation unit 100, the query type determination unit 102, the query knowledge graph search unit 110, the map data generation unit 120, the information deriving unit 130, the search result providing unit 140, the first database 150 and the second database 160 can be implemented separately or in combination with one another.

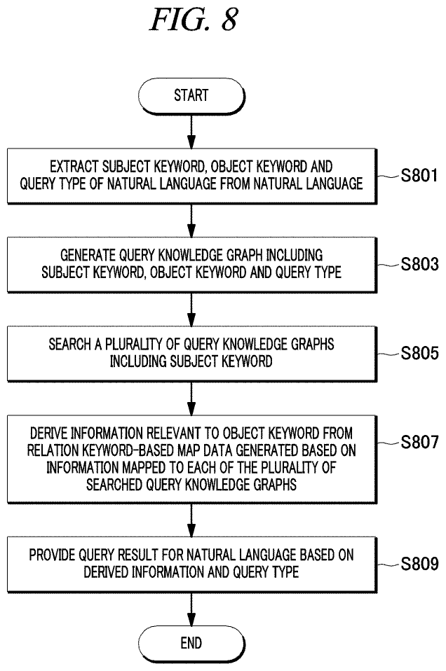

FIG. 8 is a flowchart illustrating an example processing flow for providing a result for a natural language-based query in accordance with an embodiment of the present disclosure.

Referring to FIG. 8, in process S801, the natural language-based query result providing server 10 may extract a subject keyword, an object keyword, and a query type of a natural language from the natural language.

In process S803, the natural language-based query result providing server 10 may generate a query knowledge graph including the extracted subject keyword, object keyword, and query type.

In process S805, the natural language-based query result providing server 10 may search a plurality of query knowledge graphs including the subject keyword.

In process S807, the natural language-based query result providing server 10 may derive information relevant to the object keyword from relation keyword-based map data generated based on information mapped to each of the plurality of searched query knowledge graphs.

In process S809, the natural language-based query result providing server 10 may provide a query result for the natural language based on the derived information and the query type.

Although not illustrated in FIG. 8, the natural language-based query result providing server 10 may determine the query type of the natural language based on the number of subject keywords included in the natural language and the presence or absence of an object keyword in process S801. For example, when the natural language includes a single subject keyword and an object keyword, the natural language-based query result providing server 10 may determine the query type of the natural language to be a single query. When the natural language includes an object keyword and a plurality of subject keywords, the natural language-based query result providing server 10 may determine the query type of the natural language to be a comparative advantage query. When the natural language includes a plurality of subject keywords but does not include any object keyword, the natural language-based query result providing server 10 may determine the query type of the natural language to be an abstract comparative advantage query.

Although not illustrated in FIG. 8, when the natural language includes a plurality of subject keywords including a first subject keyword and a second subject keyword, the natural language-based query result providing server 10 may search a plurality of first query knowledge graphs including the first subject keyword and a plurality of second query knowledge graphs including the second subject keyword in process S805. The natural language-based query result providing server 10 may derive information relevant to the first subject keyword and information relevant to the second subject keyword respectively from first map data generated based on information mapped to each of the plurality of searched first query knowledge graphs and second map data generated based on information mapped to each of the plurality of searched second query knowledge graphs.

Although not illustrated in FIG. 8, when the query type is a comparative advantage query, the natural language-based query result providing server 10 may derive a first value corresponding to the object keyword from the first map data and a second value corresponding to the object keyword from the second map data in process S807.

Although not illustrated in FIG. 8, when the query type is an abstract comparative advantage query, the natural language-based query result providing server 10 may derive at least one predicted object keyword based on user preference-based ranking data and may derive a first value corresponding to the predicted object keyword from the first map data and a second value corresponding to the predicted object keyword from the second map data in process S807.

Although not illustrated in FIG. 8, the natural language-based query result providing server 10 may advantageously compare the derived first and second values and may provide a search result for the natural language in process S809.

In the descriptions above, processes S801 through S809 may be divided into additional processes or combined into fewer processes depending on an exemplary embodiment. In addition, some of the processes may be omitted and the sequence of the processes may be changed if necessary.

The embodiments described and recited herein be embodied in a storage medium including instruction codes executable by a computer such as a program module executed by the computer. Besides, the data structure in accordance with the embodiment of the present disclosure can be stored in the storage medium executable by the computer. A computer-readable medium can be any usable medium which can be accessed by the computer and includes all volatile/non-volatile and removable/non-removable media. Further, the computer-readable medium may include computer storage medium. The computer storage medium includes all volatile/non-volatile and removable/non-removable media embodied by a certain method or technology for storing information such as computer-readable instruction code, a data structure, a program module or other data.

The above description of the present disclosure is provided for the purpose of illustration, and it would be understood by a person with ordinary skill in the art that various changes and modifications may be made without changing technical conception and essential features of the present disclosure. Thus, it is clear that the above-described embodiments are illustrative in all aspects and do not limit the present disclosure. For example, each component described to be of a single type can be implemented in a distributed manner. Likewise, components described to be distributed can be implemented in a combined manner.

The scope of the present disclosure is defined by the following claims rather than by the detailed description of the embodiment. It shall be understood that all modifications and embodiments conceived from the meaning and scope of the claims and their equivalents are included in the scope of the present disclosure.

We claim:

1. A server that provides a response to a natural language-based query, comprising:
a query knowledge graph generation unit that extracts a subject keyword, an object keyword and a query type of a natural language from the natural language and generates a query knowledge graph including the subject keyword, the object keyword and the query type;
a query knowledge graph search unit that searches a plurality of query knowledge graphs including the subject keyword;
an information deriving unit that derives information relevant to the object keyword from map data based on the subject keyword of each of the plurality of searched query knowledge graphs; and
a search result providing unit that provides a query result for the natural language based on the derived information and the query type.

2. The server of claim 1, further comprising:
a map data generation unit that generates the map data including a plurality of relation keywords and values corresponding to the plurality of relation keywords, respectively, based on information mapped to each of the plurality of searched query knowledge graphs.

3. The server of claim 1, wherein the query knowledge graph generation unit includes a query type determination unit that determines the query type based on a number of subject keywords included in the natural language and the presence or absence of the object keyword.

4. The server of claim 3, wherein, when the natural language includes the single subject keyword and the object keyword, the query type determination unit determines the query type to be a single query.

5. The server of claim 3, wherein, when the natural language includes a plurality of subject keywords, the query type determination unit determines the query type to be a comparative advantage query.

6. The server of claim 5, wherein
the plurality of subject keywords includes a first subject keyword and a second subject keyword,
the plurality of query knowledge graphs searched by the query knowledge graph search unit includes a plurality of first query knowledge graphs including the first subject keyword and a plurality of second query knowledge graphs including the second subject keyword, and
the information relevant to the object keyword derived by the information deriving unit is derived from first map data generated based on information mapped to each of the plurality of searched first query knowledge graphs and second map data generated based on information mapped to each of the plurality of searched second query knowledge graphs.

7. The server of claim 6, wherein, when the query type is a comparative advantage query, the information deriving unit derives a first value corresponding to the object keyword from the first map data and a second value corresponding to the object keyword from the second map data.

8. The server of claim 7, wherein the search result providing unit compares the first value and the second value and provides a query result for the natural language.

9. The server of claim 6, wherein, when the natural language does not include the object keyword, the query type determination unit determines the query type of the natural language to be an abstract comparative advantage query.

10. The server of claim 9, wherein, when the query type is an abstract comparative advantage query, the information deriving unit derives at least one predicted object keyword based on user preference-based ranking data and derives a first value corresponding to the predicted object keyword from the first map data and a second value corresponding to the predicted object keyword from the second map data.

11. The server of claim 10, further comprising:
a first database that stores a plurality of query knowledge graphs; and
a second database that stores the user preference-based ranking data,
wherein the user preference-based ranking data are data ranked for a plurality of keywords appearing in a plurality of documents collected by subjects.

12. A method for providing a response to a natural language-based query by a server, comprising:
extracting a subject keyword, an object keyword and a query type of a natural language from the natural language;
generating a query knowledge graph including the subject keyword, the object keyword and the query type;
searching a plurality of query knowledge graphs including the subject keyword;
deriving information relevant to the object keyword from map data based on the subject keyword of each of the plurality of searched query knowledge graphs; and
providing a query result for the natural language based on the derived information and the query type.

13. The method for providing a response to a natural language-based query of claim 12, further comprising:
generating the map data that includes a plurality of relation keywords and values corresponding to the plurality of relation keywords, respectively, based on information mapped to each of the plurality of searched query knowledge graphs.

14. The method for providing a response to a natural language-based query of claim 12, further comprising:
determining the query type based on the number of subject keywords included in the natural language and the presence or absence of the object keyword.

15. The method for providing a response to a natural language-based query of claim 14, wherein the determining of the query type includes determining the query type to be a single query when the natural language includes the single subject keyword and the object keyword.

16. The method for providing a response to a natural language-based query of claim 14, wherein the determining of the query type includes determining the query type to be a comparative advantage query when the natural language includes a plurality of subject keywords.

17. The method for providing a response to a natural language-based query of claim 16, wherein the determining of the query type includes determining the query type of the natural language to be an abstract comparative advantage query when the natural language does not include the object keyword.

18. A computer program that is stored in a storage medium and includes a sequence of instructions for providing a response to a natural language-based query, wherein the computer program includes a sequence of instructions that, when executed by a computing device, causes the computing device to:
extract a subject keyword, an object keyword and a query type of a natural language from the natural language,
generate a query knowledge graph including the subject keyword, the object keyword and the query type,
search a plurality of query knowledge graphs including the subject keyword,
derive information relevant to the object keyword from map data based on the subject keyword of each of the plurality of searched query knowledge graphs, and
provide a query result for the natural language based on the derived information and the query type.
